(19) United States
(12) Patent Application Publication
(10) Pub. No.: US 2004/0206304 A1
(43) Pub. Date: Oct. 21, 2004

(54) Pressurized chuck for controlling backside wafer contamination

(76) Inventor: John Edgar Menear, Santa Cruz, CA (US)

Correspondence Address: JOHN MENEAR, # 4, 1200 CAPITOLA ROAD, SANTA CRUZ, CA, 95062, US

(21) Appl. No.: 10/412,832

(22) Filed: Apr. 15, 2003

(51) Int. Cl. B05C 11/00; B05C 13/02

(52) U.S. Cl. 118/500; 118/57

(57) ABSTRACT

A pressurized chuck for semiconductor process and measurement equipment. The chuck is designed to eliminate backside wafer contamination. The pressurized chuck uses a combination of positive pressure under the wafer and clamps above the wafer edge. Wafers are held flat and stable. Preexisting particles on the wafer backside cause no problems with high spots. With a small modification, this chuck can provide an inert gas environment around the wafer.

### CROSS-REFERENCE TO RELATED APPLICATIONS

Not Applicable

### STATEMENT REGARDING FEDERALLY SPONSORED RESEARCH

Not Applicable

### REFERENCE TO A MICROFICHE APPENDIX

Not Applicable

### BACKGROUND OF THE INVENTION

1. Field of the Invention

This invention relates to the semiconductor, disk drive, and flat panel display manufacturing industries. It applies to process and measurement equipment. The pressurized chuck eliminates contact with the backside (or topside) of a semiconductor wafer except at the outside edge. The chuck may be employed by any piece of semiconductor process or measurement equipment, where the wafer is placed onto a chuck for processing or measurement.

2. Description Of Related Art

The vacuum chuck is currently the most widely used chuck design. With this design, the semiconductor wafer is placed onto a chuck, which has vacuum holes or grooves on the contacting surface. Then a vacuum is applied to hold the wafer secure and flat. This design is approaching the end of the its useful life due to advances in semiconductor technology, particularly the trend toward smaller feature sizes on the wafer.

Backside wafer contamination is currently recognized as a major problem in semiconductor wafer manufacture. When the backside of the wafer is contacted by handling equipment, contamination occurs. Some of this contamination is particle or polymer pickup. Some of this contamination is due to structural defects created on the wafer's backside. In either case, flatness at the topside of the wafer is affected when the wafer is held on a vacuum chuck. For example, a particle trapped between the backside of the wafer and the chuck creates a raised spot in the wafer. The raised spot may only be a sub-micron imperfection on the wafer's top surface. But with today's semiconductor technology, that imperfection matters.

Particles can be transferred onto the chuck during a prior process step. Or the particles may be deposited from sources near the chuck. In either case, the processing effect is cumulative. The flatness distortion affects every following process step and every following measurement step.

Modifying the chuck surface with an array of closely spaced pins has been tried as an improvement on the standard vacuum chuck. The strategy is to reduce the backside contamination by reducing the effective area of contact between the wafer and the chuck surface. But it had marginal success. The pins pushing upward and the vacuum pulling downward created an array of raised spots and lowered spots. Also, the backside contamination was not reduced in proportion to the reduced area of contact. The backside contamination became concentrated where the pins made contact.

Another concept has been proposed. It uses alternating positive pressure jets and vacuum ports. The positive pressure jets exert an upward force on the bottom of the wafer, and vacuum ports exert a downward pull. The wafer appears to float over the chuck, much like an air hockey puck floats on an air table. This solution has four problems. First, alternating raised spots and and lowered spots still exist. Second, backside wafer contact is lessened, but not eliminated. Contact images are still observable on the wafer backside. Third, the wafer moves freely in the plane of the wafer, and it rotates freely. This movement is unacceptable to virtually all processes and measurements. Fourth, the height of the wafer is not rigidly fixed, and vibration is not controlled. In optical measurements, the distance between the wafer and a lens is critical, and vibrations aren't tolerable.

### BRIEF SUMMARY OF THE INVENTION

The pressurized chuck uses four innovations:

1. a beveled circumference to the chuck surface, instead of a flat contact surface. The wafer sits onto this beveled depression, which localizes contact between the wafer and the chuck to the outside edge of the wafer.

2. an edge clamping mechanism to prevent rotation, movement in the wafer plane, or height fluctuation.

3. a flow of air into the space between the wafer and the chuck surface.

4. a restricted air exit path that develops the design pressure under the wafer.

Flatness is achieved when the downward weight of the wafer equals the upward force of the pressurized air zone acting on the area of the wafer.

The pressurized chuck solves the problems of the standard vacuum chuck, the pin-style vacuum chuck, and the chuck employing both positive and negative pressures. Specifically,

the backside of the wafer contacts the chuck only at the edge of the wafer. At worst, only the outer 2 mm of wafer radius is contacted. Normally, less than 0.5 mm is contacted. Backside particles are not transferred from the chuck to the wafer.

upward force on the wafer is equally applied. Every square millimeter of wafer surface experiences the same upward force. Alternating upward and downward

forces do not act on the wafer. Raised spots and lowered spots are not created.

if backside particles from a prior process step exist, they will not create a problem. Since these particles do not contact a hard surface, they cannot exert an upward force or distort wafer flatness.

rotation, movement in the wafer plane, and height fluctuations do not occur. The wafer (or disk or flat panel) is firmly held.

### BRIEF DESCRIPTION OF THE SEVERAL VIEWS OF THE DRAWINGS

FIG. 1 is a pictorial illustration of the current best mode contemplated. As shown, the chuck is in the load/unload position, and a wafer is approaching to load.

FIG. 2 shows them wafer 1 resting on the clamps. The chuck is still in the load/unload position.

FIG. 3 shows the loaded wafer with the wafer securely held.

FIG. 4 shows a generalized schematic for a pressurized chuck.

FIG. 5 shows the generalized schematic in FIG. 4, but with holes that deliver inert gas or purified gas to the topside of the wafer.

### DETAILED DESCRIPTION OF THE INVENTION

### A. Example Of A Working Pressurized Chuck

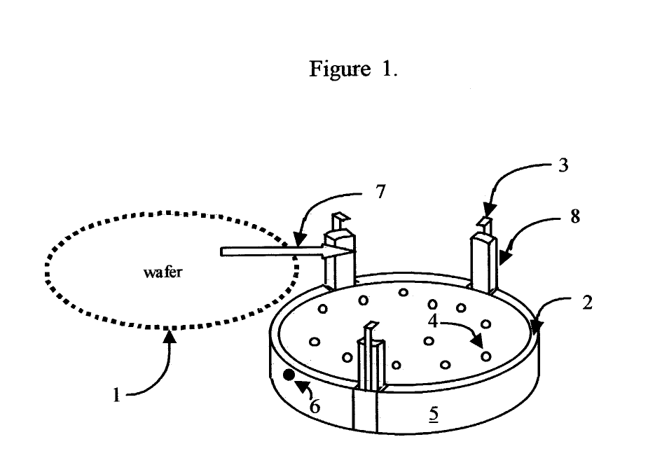

FIG. 1 shows a wafer 1 moving in the direction 7 toward the chuck 5. The clamps are in the up position, which is the load/unload position. The space beneath the clamps (in the up position) is sufficient to allow passage of a robot end effector, which is necessary for the load/unload step. Each clamp has two independently movable parts: a beveled post 8 and an upper tab 3. Both parts move vertically. The upper tab 3 may also move radially inward and outward. Air inlet holes 4 introduce filtered air or inert gas, and create a pressure under the wafer. An air escape route 6 combined with the inlet airflow rate defines the pressure achieved under the wafer. The top circumference of the chuck has a beveled edge 2, such that the height increases with increasing radius.

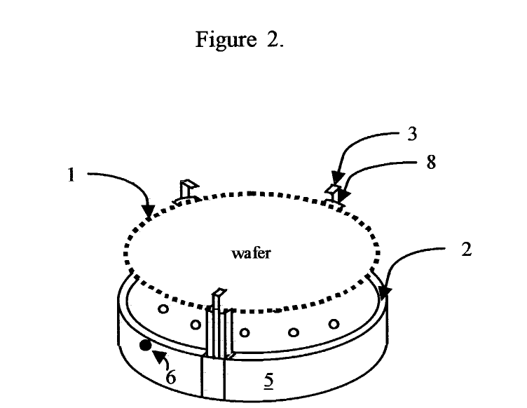

FIG. 2 shows the wafer 1 on the chuck 5, while the clamps are still in the load/unload position. The weight of the wafer 1 is supported from underneath by the beveled post 8. The upper tab 3 has not yet closed downward onto the top edge of the wafer.

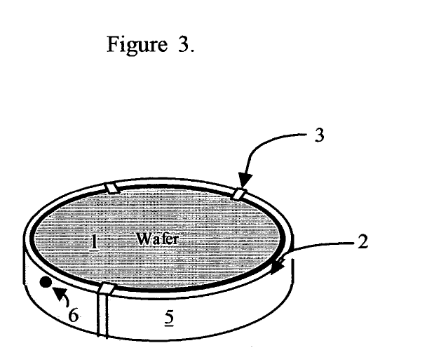

FIG. 3 shows the wafer in the process (clamps down) position. To get here, the beveled posts 8 have lowered until the beveled edge of each beveled post 3 is at the same height as the beveled edge 2 of the chuck. Then the upper tab 3 has closed to prevent any wafer movement. Under the wafer, air pressure supports the wafer in a flat orientation.

### B. Operating Principle

The operating principle is that the upward force and the downward force operating on the wafer are equal. The downward force is the wafer weight. The upward force is “pressure times area”.

The total airflow required under the wafer is small. For example, to “float” a 0.3 pound 300 mm wafer requires roughly 0.05-0.1 inches of water pressure under the wafer. As examples, 0.05-0.1 inches of water can be achieved using 1 liter/minute of airflow and limiting the escape to 0.005 square inches. Or the airflow could be 30 liter/minute and the escape area could be 0.13 square inches. As a design consideration, the wafer circumference must conform well to the beveled edge of the stage, and the unplanned leakages must be minimized. This requires tight manufacturing tolerances for the beveled edge 2.

### C. Other Designs

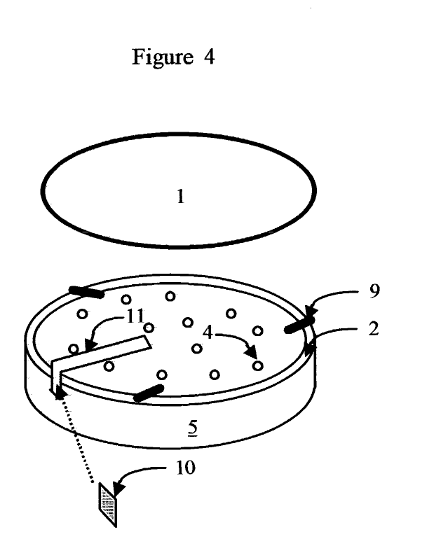

A generalized configuration for a pressurized chuck is shown in FIG. 4. A working model requires the following basics:

a beveled edge 2 that the wafer rests on. The bevel must be higher at the larger radius. The goals are to minimize contact between the chuck 5 and wafer 1 and to provide a seal that confines the pressurized air.

an air space between the chuck 5 and the wafer 1.

air holes 4 that allow a flow of filtered air into the space between the chuck and the wafer.

clamps 9 to hold the wafer. A small edge of the top wafer surface will be gripped since a downward force vector is needed. A sloped clamp edge is useful to further reduce wafer contact. A variety of mechanisms are useful here. Clamps can rotate, move out and in, move vertically, or use a combination of the preceding.

a space for a robot end effector to load and unload a wafer. The raising-and-lowering pins that are in common use today are not preferred because they cause backside contamination. In FIG. 4, this space is exemplified with a groove 11 that conforms to a straight end effector.

a mechanism to seal the end effector space after delivery. This is needed to

maintain pressure under the wafer. It could be a door 10 that rotates, hinges, slides, or moves linearly. (In FIG. 1, the clamping mechanism inherently handled this sealing requirement.)

mechanisms for the door and clamps may utilize hydraulics, pneumatics, motors, springs, solenoids, actuators, or combinations thereof.

### D. Secondary Functions

Where wafer handling in an inert gas is required, the gas could be nitrogen, helium, neon, argon, krypton, or Xenon. If airborne molecular contaminants are detrimental, airborne molecular contaminant filters can be placed in line.

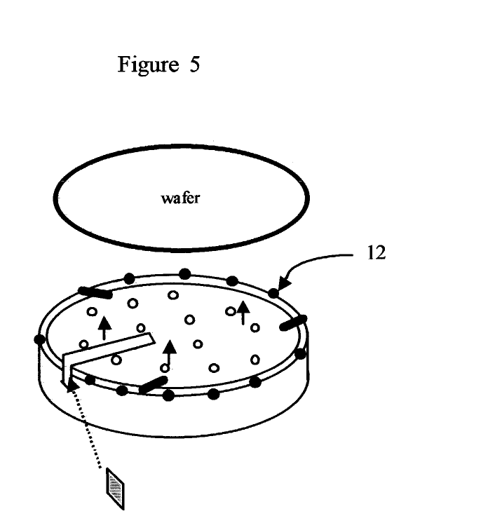

In FIG. 5, some of the inert gas is ducted through topside holes 12 to the wafer topside. The purpose is to create a thin layer of inert gas over the topside. Even in an air environment, the wafer surface is protected with a thin layer of inert gas.

### E. Design Details

A design consideration is vibration caused by the flowing air. Vibration tends to develop in response to standing waves, which depend on overall geometry. The situation is analogous to an organ pipe. The solution to prevent vibration is to vary both the inflow hole size and the direction of air entry. In addition, hole placement will be randomized. The goal is to disrupt any chance that standing waves will develop.

Varying the size and location of the air entry holes may also be used to enhance flatness of the loaded wafer. Aimed velocity pressure may be utilized as a design tool.

In diagrams 1 to 5, rotary motion would be performed at a level below chuck. That is, rotation would occur inside the stage that supports the chuck. It is also acceptable to build rotation into the chuck.

### F. Consideration Of Warped Wafers

If the wafers are warped due to manufacture, the pressurized chuck will not straighten them. However, it is reasonable to expect such warping would show itself as low slopes over large wafer distances. Low slopes can be addressed with corrective software. If warpping becomes a problem, software solutions are expected to develop in response to the pressurized chuck However, such software solutions are beyond the scope of this application.

The invention claimed is:

1. A pressurized chuck for preventing backside wafer contamination, comprising:
a chuck with a beveled edge on the top surface.
an air space between the chuck and the wafer.
a source of filtered air or inert gas.
air holes that allow a flow of filtered air into the space between the chuck and the wafer.
a controlled exit opening for the filtered air.
clamps to hold the wafer in place with a downward force at the wafer edge.
space for a robot end effector to load and unload a wafer without using raising-and-lowering pins.

2. Claim 1 where the beveled edge is split between a stationary section and clamping sections as shown in FIG. 1.

3. Claim 1 where beveled edge is higher at the larger radius.

4. Claim 1 where the inlet air or inert gas enters through irregular sized holes at a variety of angles to suppress vibration or improve flatness.

5. Claim 1 where a door (10) is used to close the space used by the robot end effector and maintain pressure beneath the wafer.

6. Claim 5 where the door closes with a hinge.

7. Claim 5 where the door closes by rotation.

8. Claim 5 where the door moves linearly to close.

9. Claim 5 where the door rises to close.

10. Claim 1 where the clamps move vertically, and are formed from parts (3) and (8) as described in FIG. 1.

11. Claim 1 where clamps rotate into the closed position.

12. Claim 1 where clamps move in to close and out to open.

13. Claim 1 where clamps move up and down to close or open.

14. Claim 1 where clamps have a sloped surface to further minimize wafer contact.

15. Claim 1 where rotation capability is built into the chuck.
